(19) United States
(12) Patent Application Publication
(10) Pub. No.: US 2008/0023979 A1
(43) Pub. Date: Jan. 31, 2008

(54) Motor Vehicle Interior Fitting and Production Method Thereof

(76) Inventors: Sebastien Trillat, Poissy (FR); Freddy Stoof, Horbourgwihr (FR)

Correspondence Address: YOUNG & THOMPSON, 745 SOUTH 23RD STREET, 2ND FLOOR, ARLINGTON, VA, 22202, US

(21) Appl. No.: 11/629,523

(22) PCT Filed: Jun. 14, 2005
(86) PCT No.: PCT/FR05/01478

§ 371 Date: Feb. 16, 2007

(30) Foreign Application Priority Data
Jan. 12, 2006 (FR) 04 06486

(51) Int. Cl. B60K 37/00; B29C 65/00; B60R 13/02

(52) U.S. Cl. 296/70; 264/46.5

(57) ABSTRACT

The invention relates to a motor vehicle interior fitting which is characterised in that it consists of: a plastic insert (1) comprising a first finish area and a second finish area having a different finish to that of the first, the second area being disposed next to the first area along a connecting line and being moulded therewith; and a secondary element (2) which is solidly connected to the insert and which is moulded to the insert opposite the connecting line, such as to cover same.

The invention relates to a motor vehicle interior fitting of plastics material comprising a plurality of zones having different appearances.

Motor vehicle dashboards are known which comprise zones having different appearances and in particular three zones which have different colours or more generally different appearances and which extend successively from the windscreen line to the bottom of the dashboard. The differences in appearance may be of very different types. More precisely, different appearances will be understood below to be:
on the one hand, different aesthetic appearances, for example, the three zones have different colours and/or different grains and/or different matt finishes and/or different gloss finishes, and
on the other hand, different mechanical properties, for example, the three zones have different levels of flexibility, and/or different mechanical strengths, and/or different textures.

These various types of difference can be combined, in so far as two appearance regions can be simultaneously different in terms of colour, grain, gloss finish and mechanical properties.

In order to produce dashboards of this type having regions having different coloration or more generally different appearances, it is possible to break down the dashboard into three separate elements which correspond to each of the regions of a particular colour or appearance, each of these separate portions is moulded and they are then assembled by means of adhesive-bonding or welding. The design of a dashboard of this type and the associated tools is complex owing in particular to the control of the production and assembly tolerances between the three elements, control of the zones of the assembly interfaces. Furthermore, a production method of this type has the disadvantage of being relatively complex to implement, leading to lengthy production cycle times which are particularly incompatible with the economical and production volume requirements of mid-range or economy-range vehicles. In order to facilitate the design and production of dashboards of this type, when the differences in appearance result only from the colour, it is possible to carry out localised painting operations which correspond to each of the specific colour regions. However, this technique has the disadvantage, as the one above, of leaving visible connection zones between two adjacent regions of different colour. Since these connection zones between two adjacent colour regions are not always well defined or clearly indicated, faults in appearance result.

The problem which arises in the production of dashboards occurs more generally in the production of motor vehicle interior fittings.

The object of the present invention is to overcome these disadvantages by providing a means for producing a motor vehicle interior fitting comprising a plurality of appearance zones having a different appearance, and in particular a dashboard comprising three regions which have different colours or more generally different appearances and which extend from the windscreen line to the bottom of the dashboard, which means is simple to carry out and, at the same time, results in a good appearance for the finished fitting.

To this end, the invention relates to a motor vehicle interior fitting which comprises an insert of plastics material which has a first appearance zone and a second appearance zone whose appearance is different from the appearance of the first appearance zone, and which is adjacent to the first appearance zone along a connection line, and which is cast with the first appearance zone, and a secondary element which is fixedly joined to the insert and which is attached by means of moulding so as to face and overlay the connection line.

Preferably, the insert of plastics material is produced by means of simultaneous or sequential controlled injection-moulding of two plastics materials having a different appearance.

The two injection-moulded plastics materials may be constituted by the same polymer but comprise different additives.

In particular, the plastics material from which one appearance zone is constituted may comprise additives which are intended to confer thereon a good level of impact resistance.

The two plastics materials from which the insert is constituted may be of different colours.

The two appearance zones of the insert may also have a different grain.

The two plastics materials from which the insert is constituted are preferably of polypropylene, to which at least an additive and a colorant are optionally added.

The secondary element may be constituted by polyurethane to which a colorant is added.

In particular, the two appearance zones of the insert and the secondary element may be of different colours.

The two injection-moulding components which correspond to the two appearance zones of the motor vehicle interior fitting may have a different grain which brings about a different aesthetic appearance for each zone.

In one configuration, the secondary element comprises a composite appearance comprising a coloured appearance skin which is, for example, of PVC or TPU, produced, for example, by means of rotational moulding, or thermo-moulding, and a layer of foam which is constituted, for example, by expanded polyurethane.

Preferably, the three zones having different appearances at least have different colours, however, in one configuration, the secondary element may take the colour and/or the aesthetic appearance of one of the two zones of the insert.

The invention also relates to a method for producing a motor vehicle interior fitting according to which a bi-material insert is produced by means of controlled simultaneous and/or sequential injection-moulding of two plastics materials having different colours and/or appearances, then the secondary element is produced and fixedly joined to the insert.

In order to produce and fixedly join the secondary element to the insert, it is possible to arrange the insert in a foaming mould with an appearance skin, at least facing the connection zone of the two appearance zones of the insert having different appearances, and the first component and the appearance skin are fixedly joined by means of foaming a plastics material.

It is also possible to produce and fixedly join the secondary element to the insert using a method for overmoulding the insert on an appearance skin or using a method for overmoulding a secondary element on an insert.

The method can be implemented on a flexible production line which allows the secondary element to be produced and fixedly joined to the insert, both by means of foaming and overmoulding. It is then possible, for each component produced, to select the production method in accordance with the intended use thereof, for example, in accordance with the quality of the vehicle on which it has to be mounted.

The motor vehicle interior fitting may be, for example, a dashboard, a door panel or a cabinet element.

The invention will now be described in greater detail, but in a non-limiting manner, with reference to the appended Figures, in which:

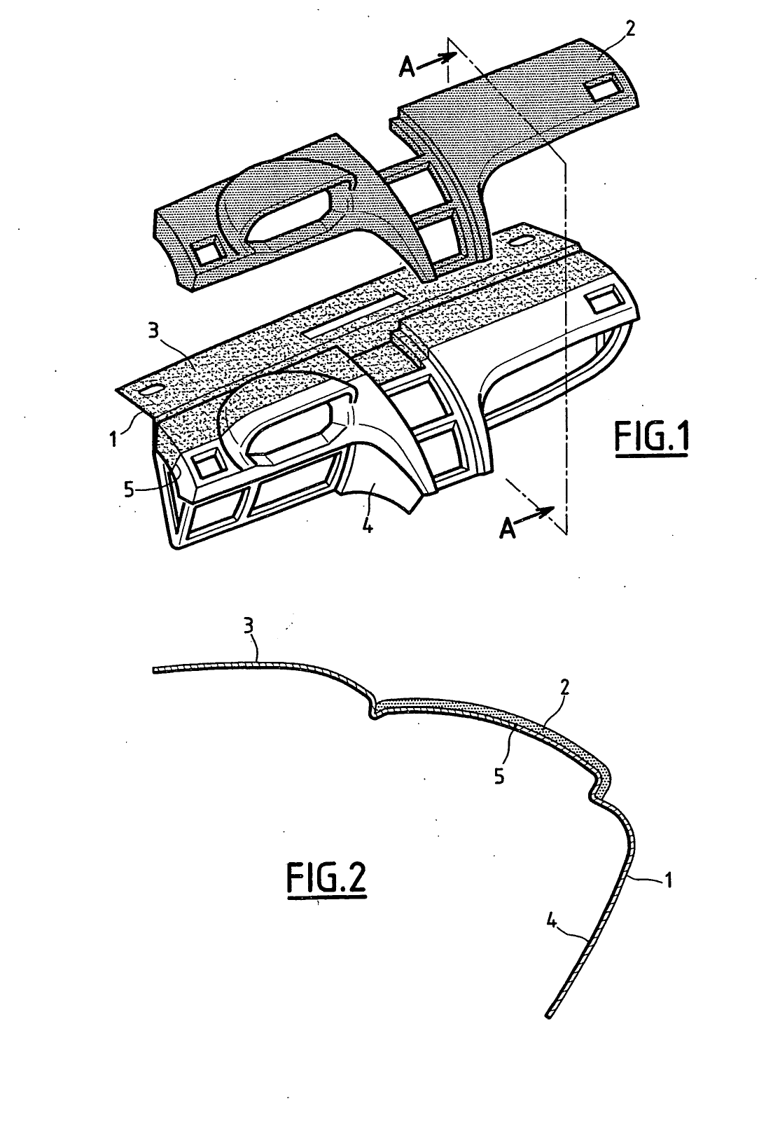

FIG. 1 is a perspective view of a dashboard having three differently coloured regions,

FIG. 2 is a sectioned view along AA of the dashboard of FIG. 1 produced according to a possible embodiment of the invention.

The dashboard illustrated in FIG. 1 comprises a first component or insert 1 which constitutes a dashboard member, and a second component or secondary element 2 which constitutes a cover. These components are assembled as will be described below.

The dashboard member 1 is a component of plastics material produced by means of injection-moulding two plastics materials which differ at least in terms of colour, optionally in terms of aesthetic appearance, or even optionally in terms of mechanical properties. This dashboard member 1 comprises a first portion 3 which is located close to the windscreen line, and a second portion 4 which is located at the bottom of the dashboard. The first portion 3 is moulded in a plastics material of a first colour, and the second portion 4 is produced in a plastics material of another colour. The two portions 3 and 4 constitute appearance zones having different aesthetic appearances. As has been mentioned, these portions may also have different mechanical properties, in particular the portion 4, which is the bottom portion, may be produced in a material which is designed so as to have a good level of impact resistance. In particular, the two portions 3 and 4 of the dashboard member 1 may be produced from polypropylene optionally complemented by an additive and a colorant, the polypropylene being injection-moulded in an injection mould which comprises two independent bars which are hot and which are supplied by a bi-material press. The bi-material press injects in a controlled manner, simultaneously and/or sequentially, on the one hand, a first polymer which is constituted by polypropylene and a first colorant which is intended to produce the portion 3 of the dashboard member 1, located close to the windscreen line and, on the other hand, a second plastics material which is constituted by polypropylene, to which an additive is added which is intended to confer thereon properties of impact resistance and a second colorant, this second plastics material being intended to produce the second portion 4 of the dashboard member 1, located towards the bottom of the dashboard. This technique of bi-material injection-moulding is known per se, and simply assumes that the two plastics materials which are moulded simultaneously or sequentially have a chemical compatibility which allows a good structural continuity of the dashboard member at the join of the two zones, and moulding properties which are mutually compatible, in particular melting temperatures or moulding temperatures which are comparable; these melting temperatures can be adjusted by metering the additives which are added to the polypropylene. A person skilled in the art will know how to carry out the required adjustments.

The mould may have two different grains for the first and the second portion of the dashboard member, respectively. This difference in grain provides a different matt and/or gloss finish between the two injected portions of the dashboard member.

The component obtained in this manner is a component which comprises two portions having at least colours, more generally, appearances and optionally properties which are different. These two portions are separated by a separation line 5 which is not always very clear. In order to conceal this separation line and to produce a region of the dashboard in a third colour, a cover or an attached fascia 2 is used and is arranged at least facing the separation line 5 of the two portions 3 and 4 of the member of the dashboard.

In all cases, the cover or fascia or, more generally, the secondary element 2, is attached to the member of the dashboard by means of moulding. As will be seen below, the term moulding used in this instance includes any method of the type involving overmoulding or foaming of plastics material.

In a first embodiment, a foaming method is used in order to produce the cover or secondary element 2 and associate it with the dashboard member or insert 1.

According to this method which is well known per se,
the dashboard member 1 obtained by means of injection-moulding polypropylene is arranged in the foaming mould,
an appearance skin of plastics material is arranged in the foaming mould at least facing the separation line 5, thus defining a foaming volume,
an expandable foam of plastics material is injected into the foaming volume, between the dashboard and the appearance skin,
the foam is allowed to expand in the foaming volume, thus fixedly joining the appearance skin to the dashboard member by means of the foam.

The secondary element 2 is thus produced which constitutes the cover which will conceal the connection line 5 between the portions 3 and 4 of the dashboard member 1.

The plastics material which constitutes the appearance skin may be, for example, PVC or TPU. The appearance skin may be produced, for example, in accordance with methods for rotational moulding or thermo-moulding. The expandable plastics material which constitutes the layer of foam may be, for example, expandable polyurethane.

In a second embodiment of the overmoulding type, the dashboard member 1 is first produced, then it is arranged in a mould which has a shape which is suitable for allowing the production of the cover. A plastics material is then injected in order to produce the cover. The cover and the dashboard member are then fixedly joined to each other.

In a third embodiment, also of the overmoulding type, the cover which comprises the appearance skin with or without foam is arranged in the injection mould which is intended to produce the member of the dashboard before the bi-injection operation is carried out, then the bi-injection operation is carried out in order to produce the member of the dashboard. The cover is then an integral component of the dashboard.

From the methods which have been described, the method according to which the secondary element is attached by means of moulding on the insert, leads to fitting components which are more suitable for top of the range vehicles than the overmoulding methods.

Since the insert is suitable for the two methods of foaming or overmoulding, in order to produce the fitting, the method by means of which the secondary element is attached is selected in accordance with the intended use thereof, that is to say, the quality (high or low) of the vehicle on which the fitting component will be mounted.

The two methods can be implemented on the same flexible production line whose operating mode is selected in accordance with the quality of the component it is desirable to produce.

The selection of the segmentation of the appearance zones is provided purely by way of illustration and of course numerous segmentation variants may be envisaged, without departing from the scope of the invention.

In the same manner, the use of the invention for other interior components of motor vehicles, such as, for example, door panels, or cabinet-type elements may be envisaged, without departing from the scope of the invention.

Generally, these are motor vehicle interior fittings which comprise an insert which comprises two appearance zones having different appearances, and a secondary element which conceals the connection zone of the two appearance zones of the insert.

1. Motor vehicle interior fitting, characterised in that it comprises an insert (1) of plastics material which has a first appearance zone and a second appearance zone whose appearance is different from the appearance of the first appearance zone, and which is adjacent to the first appearance zone along a connection line, and which is cast with the first appearance zone, and a secondary element (2) which is fixedly joined to the insert and which is attached to the insert by means of moulding so as to face and overlay the connection line.

2. Motor vehicle interior fitting according to claim 1, characterised in that the insert (1) of plastics material is produced by means of simultaneous or sequential controlled injection-moulding of two plastics materials having a different appearance.

3. Motor vehicle interior fitting according to claim 2, characterised in that the two injection-moulded plastics materials are constituted by the same polymer but comprise different additives.

4. Motor vehicle interior fitting according to claim 3, characterised in that the plastics material from which one appearance zone (4) is constituted comprises additives which are intended to confer thereon a good level of impact resistance.

5. Motor vehicle interior fitting according to claim 1, characterised in that the two plastics materials from which the insert is constituted are of different colours.

6. Motor vehicle interior fitting according to claim 1, characterised in that the two appearance zones of the insert have a different grain.

7. Motor vehicle interior fitting according to claim 1, characterised in that the two plastics materials from which the insert is constituted comprise polypropylene, to which at least an additive and a colorant are optionally added.

8. Motor vehicle interior fitting according to claim 1, characterised in that the secondary element (2) comprises a composite appearance comprising a coloured appearance skin of plastics material, such as PVC or TPU, and a layer of foam which is constituted, for example, by expanded polyurethane.

9. Motor vehicle interior fitting according to claim 8, characterised in that the secondary element (2) is constituted by polyurethane to which a colorant is added.

10. Motor vehicle interior fitting according to claim 1, characterised in that the two appearance zones (3, 4) of the insert and the secondary element (2) are of different colours.

11. Motor vehicle interior fitting according to claim 1, characterised in that it constitutes a dashboard, a door panel, or a cabinet element.

12. Method for producing a motor vehicle interior fitting according to claim 1, characterised in that a bi-material insert is produced by means of controlled simultaneous and/or sequential injection-moulding of two plastics materials having different appearances, then the secondary element is produced and fixedly joined to the insert by means of moulding.

13. Method according to claim 12, characterised in that, in order to produce and fixedly join the secondary element to the insert, the insert is arranged in a foaming mould, an appearance skin is arranged in the foaming mould, at least facing the separation line of the two appearance zones of the insert, an expandable foam of plastics material is injected between the insert and the appearance skin and the foam is allowed to expand.

14. Method according to claim 12, characterised in that, in order to produce and fixedly join the secondary element to the insert, a method for overmoulding the insert on an appearance skin or a method for overmoulding a secondary element on an insert is used.

15. Method according to claim 12, characterised in that it is implemented on a production line which allows the secondary element to be produced and fixedly joined to the insert, both by means of foaming and overmoulding and, for each component, the production method, foaming or overmoulding, is selected in accordance with the quality of the vehicle for which the component is intended.
